(19) United States
(12) Patent Application Publication
(10) Pub. No.: US 2026/0267363 A1
(43) Pub. Date: Sep. 10, 2026

(54) FOOT PUMP

(71) Applicant: Senliao Lou, Yuyao (CN)

(72) Inventor: Senliao Lou, Yuyao (CN)

(21) Appl. No.: 19/664,880

(22) Filed: Apr. 30, 2026

(30) Foreign Application Priority Data
Apr. 9, 2026 (CN) 202610462311.2

(51) Int. Cl. G05D 16/20; H02J 7/80

(52) U.S. Cl. CPC G05D 16/2066; H02J 7/80

(57) ABSTRACT

The present invention discloses a foot pump, comprising a housing, a battery pack, an air pump, and a foot switch board. The air pump is connected with an air pump data detection module and an air pump power control module; the air pump data detection module is used for detecting an internal air pressure value of the object to be inflated; when the air pressure is lower than a set value, the air pump is automatically started through the air pump power control module to replenish air; and when the air pressure is automatically adjusted to the set value, the air pump automatically stops and maintains the pressure, achieving the functions of automatic pressure holding and automatic air replenishment. The present invention has the functions of automatic inflation, automatic shutdown, automatic pressure holding, automatic detection, automatic air replenishment and lighting.

### CROSS-REFERENCE TO RELATED APPLICATIONS

This application claims priority to Chinese Patent Application No. 202610462311.2, filed on Apr. 9, 2026, which is hereby incorporated by reference in its entirety.

### TECHNICAL FIELD

The present invention relates to a foot pump.

### BACKGROUND

The air pump is a common inflation tool, which is widely used in the inflation operations of vehicle tires, air beds, balls and other items. At present, emergency air pumps on the market are mainly divided into two categories: electric air pumps and human-driven foot pumps. Although the electric air pumps have a high inflation speed and a high degree of automation, the existing products generally have the following problems: the battery life is insufficient, and a significant gap exists between the nominal parameters and the actual usage; the accuracy of air pressure control is not high, so overinflation or underinflation easily occurs; and some products have complex operation interfaces, which are not user-friendly for the elderly who are not familiar with electronic products. In addition, the electric air pumps usually need to be operated by hand or set up by bending over, which still causes inconvenience for users with limited mobility. The traditional foot pump needs to be repeatedly stepped by human power to generate air pressure, has simple structure and no need of power supply but low inflation efficiency, and causes great physical exertion of the user. For the elderly, the disabled and people with weaker physical strength, continuous stepping for a long time will quickly cause fatigue, making it difficult to complete inflation. Moreover, the traditional foot pump lacks the functions of air pressure detection and automatic control, with the inflation effect completely dependent on the experience and physical strength of the user, making it difficult to meet the inflation requirements of automobile tires and other items that need higher air pressure.

Therefore, in the prior art, an air pump product that can not only achieve automatic inflation by using electricity, but also be started and operated by simply stepping on, which is particularly suitable for the elderly, the disabled and people with limited mobility is lacked.

### SUMMARY

In view of the above defects in the prior art, the purpose of the present invention is to provide a foot pump.

The technical solution of the present invention is as follows: a foot pump comprises:

A housing, configured to be placed on the ground;

A battery pack, arranged inside the housing and used as a power supply;

An air pump, arranged inside the housing;

An air pipeline, connected with an air outlet of the air pump and used for delivering compressed gas to an object to be inflated;

A foot switch board, arranged on the upper surface of the housing for a user to touch with a foot or an object to trigger inflation operation;

The air pump is connected with an air pump data detection module and an air pump power control module, the air pump data detection module is used for detecting an internal air pressure value of the object to be inflated, when the air pressure is lower than a set value, the air pump is automatically started through the air pump power control module to replenish air, and when the air pressure is automatically adjusted to the set value, the air pump automatically stops and maintains the pressure, achieving the functions of automatic pressure holding and automatic air replenishment.

Further, the foot pump comprises a controller, the controller is connected with a foot switch, the air pump data detection module, the air pump power control module, the battery pack, a zero-power shutdown control circuit, a temperature protection control module, a bidirectional USB circuit, an LED lighting lamp, an LED lamp switch circuit, and a battery level and air pressure display module, the battery pack is connected with the air pump, the air pump is connected with the air pump data detection module and the air pump power control module, and the battery pack is connected with the zero-power shutdown control circuit and the bidirectional USB circuit.

Further, the controller is provided with a voltage detection module, and the voltage detection module is connected with the battery pack; the controller is provided with an on/off management module, and the on/off management module is connected with the zero-power shutdown control circuit; the controller is provided with a charging monitoring module, and the charging monitoring module is connected with the battery pack; the controller is provided with a temperature detection module, and the temperature detection module is connected with the temperature protection control module; the controller is provided with a USB control module and a charging control module, and the USB control module and the charging control module are connected with the bidirectional USB circuit; the controller is provided with an LED lighting lamp control module, the LED lighting lamp control module is connected with the LED lighting lamp, and an output terminal of the LED lamp switch circuit is connected with an input terminal of the LED lighting lamp control module; and the controller is provided with a battery level and air pressure display control module, and the battery level and air pressure display control module is connected with the battery level and air pressure display module.

Further, the battery pack is a titanium battery.

Further, the rear end of the top of the housing is provided with a panel, the panel has switchable air pressure units, and when the object is inflated to the set value, the foot pump automatically stops inflating and automatically cuts off the power supply of the battery pack.

Further, a plurality of air nozzle adapters are detachably fixed at the bottom of the housing by means of clamping, the foot switch board is arranged at the front end of the top of the housing, and the rear end of the housing is provided with a charging and discharging port.

Further, the housing is composed of an upper housing and a lower housing distributed above and below, the air nozzle adapters and the air pipeline are installed at the bottom of the lower housing, and the panel and the foot switch board are installed at the top of the upper housing; the rear end of the housing is provided with a TYPE-C board PCB and a TYPE-C cover for covering the charging and discharging port; an anti-vibration rubber pad is arranged between the air pump and the housing; and a mainboard, a sensor and a battery pack PCB are also installed in the housing.

Further, the foot switch located below the foot switch board is installed in the upper end of the housing, and a spring for driving the foot switch board to reset is installed between the foot switch board and the upper end of the housing.

Further, the surface of the foot switch board is provided with diversion trenches.

The present invention has the following beneficial effects:

The present invention is easy to operate, time-saving and labor-saving, and the user only needs to touch the foot switch board with a foot or any object to start inflation, with no need to bend over or hold, so the present invention is particularly suitable for the elderly, the disabled and people with limited physical strength;

The internal air pressure of the object to be inflated is monitored in real time through the air pump data detection module, and combined with the air pump power control module, the air pressure value of the object to be inflated can be automatically adjusted according to the set air pressure value; when the object is inflated to the set value, the foot pump automatically stops and cuts off the power supply of the battery pack to prevent overinflation; the foot pump also has the function of automatic pressure holding, maintaining a stable pressure after inflation is completed; and when the air pressure is lower than the set value, the foot pump can automatically replenish air;

The titanium battery is used as the power supply, which is not flammable or explosive and has high safety; with the arrangement of the zero-power shutdown control circuit, the power supply is automatically cut off after standby or completion of charging, greatly reducing power loss; the bidirectional USB circuit supports external charging, enabling the air pump to also serve as an emergency mobile power supply; and the temperature protection control module monitors the operating temperature in real time to prevent overheat damage;

The panel displays the current air pressure, set air pressure, battery level and other information in real time in the form of numbers and icons, and the air pressure units can be freely switched to meet the usage habits of different users;

The LED lighting lamp is arranged inside, which can provide illumination at night or in an environment with insufficient light, making it convenient for users to connect the air nozzle or check the inflation status, thereby enhancing practicality and safety;

The plurality of air nozzle adapters are detachably fixed at the bottom of the housing by means of clamping, which is convenient for storage and less likely to be lost; the surface of the foot switch board is provided with diversion trenches, which can effectively drain water and prevent slipping, making it safer to use in rainy or humid environments; and the anti-vibration rubber pad is arranged between the housing and the air pump to reduce operating noise and vibration.

### BRIEF DESCRIPTION OF THE DRAWINGS

FIG. 1 is a functional block diagram of the present invention;

FIG. 2A-1 is a partial circuit diagram of a controller and a battery level and air pressure display module of the present invention;

FIG. 2A-2 is a partial circuit diagram of a controller and a battery level and air pressure display module of the present invention;

FIG. 2A-3 is a partial circuit diagram of a controller and a battery level and air pressure display module of the present invention;

FIG. 2A-4 is a partial circuit diagram of a controller and a battery level and air pressure display module of the present invention;

FIG. 2A-5 is a partial circuit diagram of a controller and a battery level and air pressure display module of the present invention;

FIG. 2A-6 is a partial circuit diagram of a controller and a battery level and air pressure display module of the present invention;

FIG. 2A-7 is a partial circuit diagram of a controller and a battery level and air pressure display module of the present invention;

FIG. 3 is a circuit diagram of a bidirectional USB circuit of the present invention;

FIG. 4 is a circuit diagram of a charging control module of the present invention;

FIG. 5 is a circuit diagram of an air pump data detection module of the present invention;

FIG. 6 is a circuit diagram of a temperature protection control module of the present invention;

FIG. 7 is a circuit diagram of an air pump power control module of the present invention;

FIG. 8 is a circuit diagram of a foot switch and a zero-power shutdown control circuit of the present invention;

FIG. 9 is a circuit diagram of an air pump of the present invention;

FIG. 10 is an overall structural schematic diagram of the present invention;

FIG. 11 is another overall structural schematic diagram of the present invention;

FIG. 12 is an exploded schematic diagram of the present invention.

In the figures: 1—housing, 1.1—upper housing, 1.2—lower housing, 2—battery pack, 3—air pump, 4—air pipeline, 5—foot switch board, 5.1—diversion trench, 6—air pump data detection module, 7—air pump power control module, 8—controller, 9—foot switch, 10—zero-power shutdown control circuit, 11—temperature protection control module, 12—bidirectional USB circuit, 13—LED lighting lamp, 14—LED lamp switch circuit, 15—battery level and air pressure display module, 16—voltage detection module, 17—on/off management module, 18—charging monitoring module, 19—temperature detection module, 20—USB control module, 21—charging control module, 22—LED lighting lamp control module, 23—battery level and air pressure display control module, 24—panel, 25—air nozzle adapter, 26—charging and discharging port, 27—TYPE-C board PCB, 28—TYPE-C cover, 29—anti-vibration rubber pad, 30—mainboard, 31—sensor, 32—battery pack PCB, and 33—spring.

### DESCRIPTION OF EMBODIMENTS

In order to understand the technical solution of the present invention more intuitively and completely, the non-restrictive features are described as follows in combination with the drawings of the present invention:

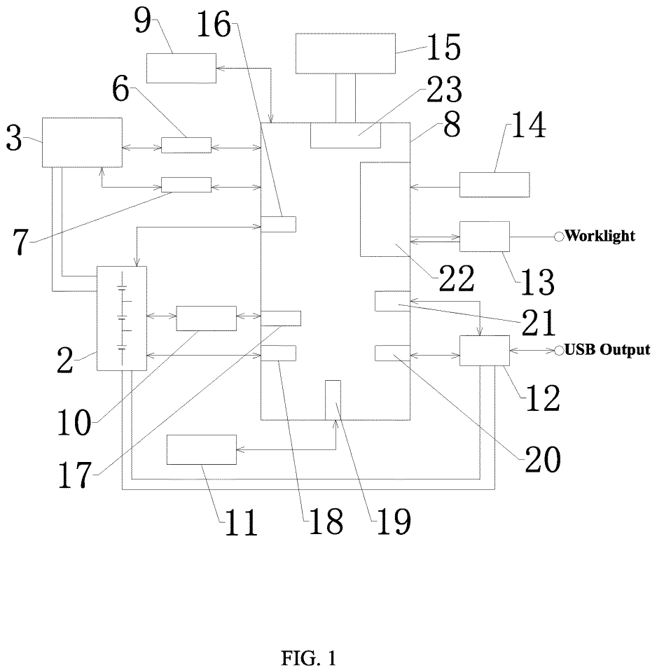

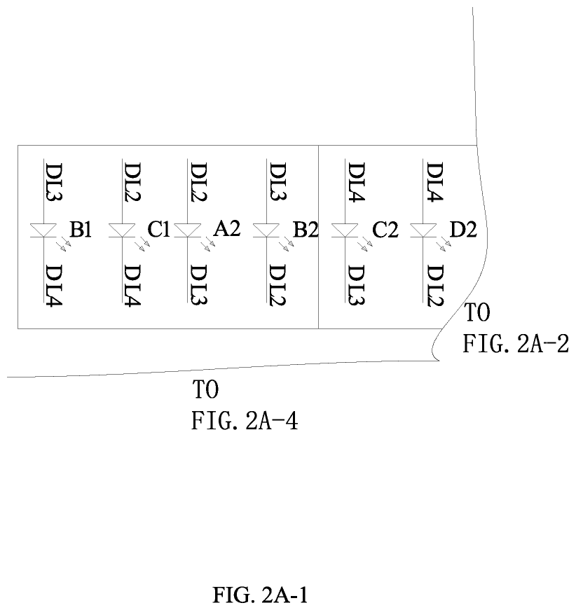

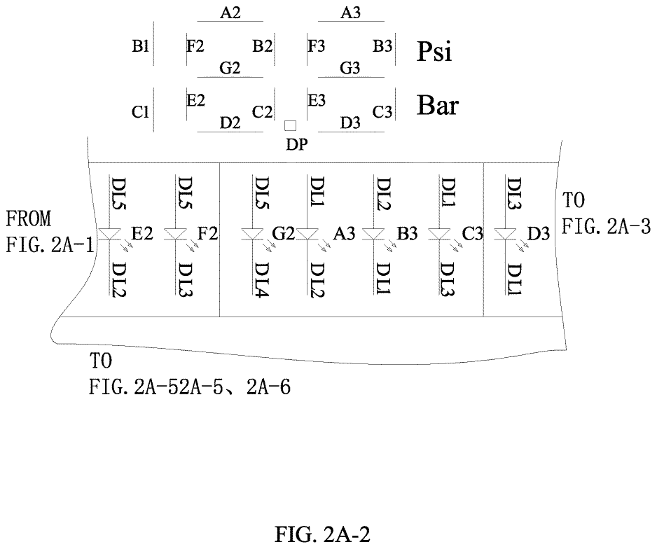

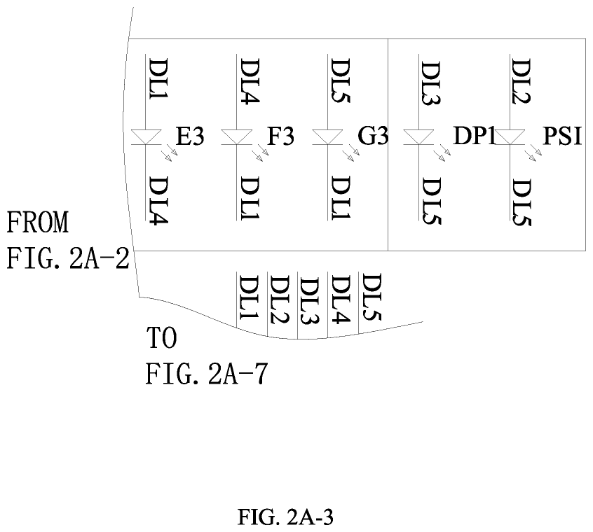

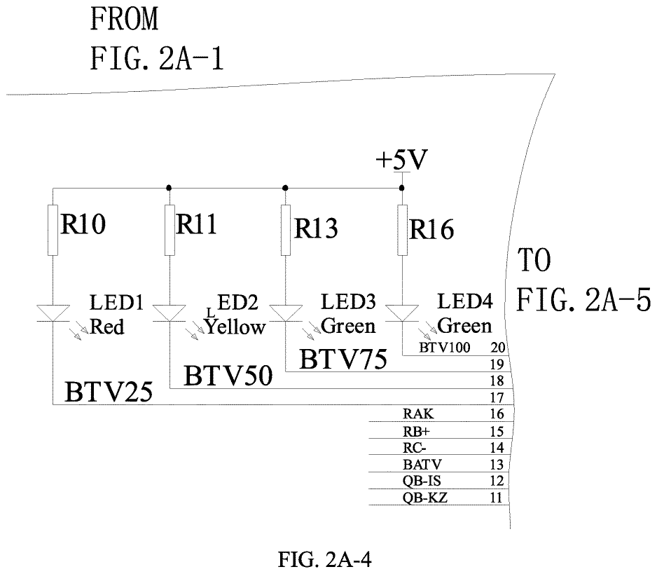

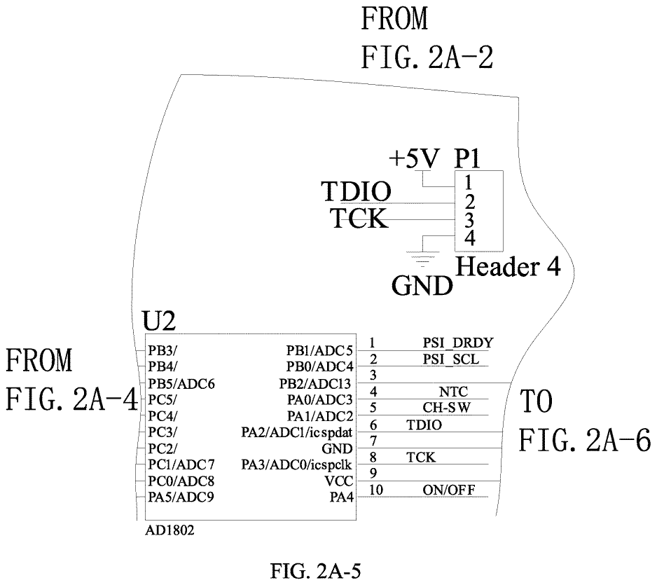

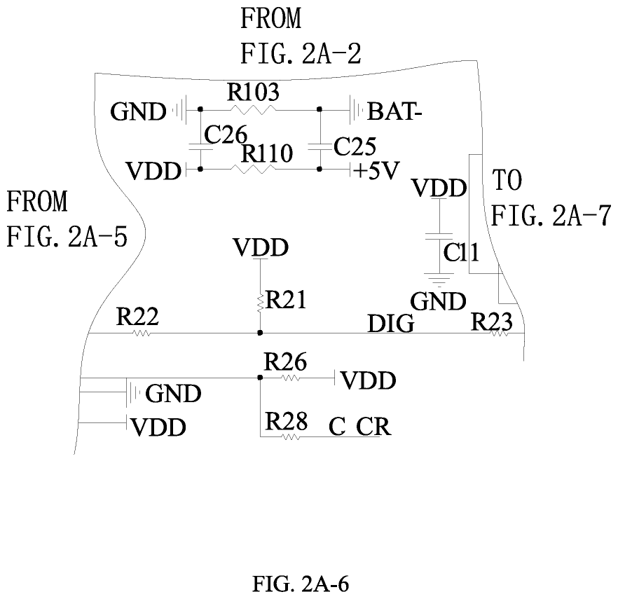

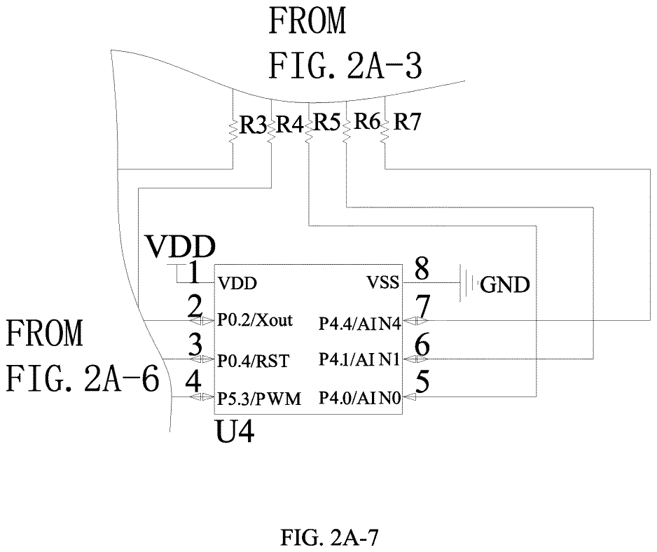

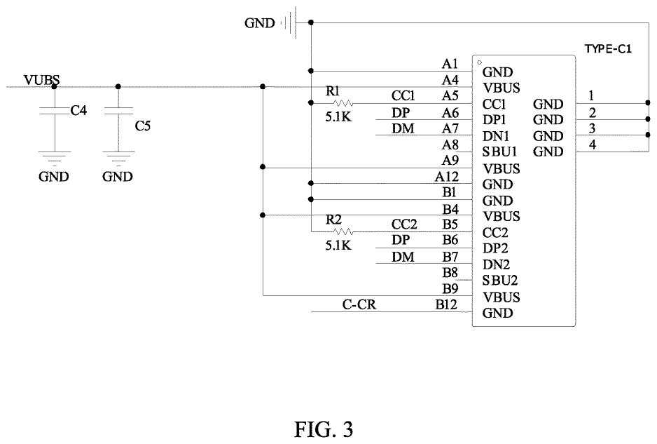

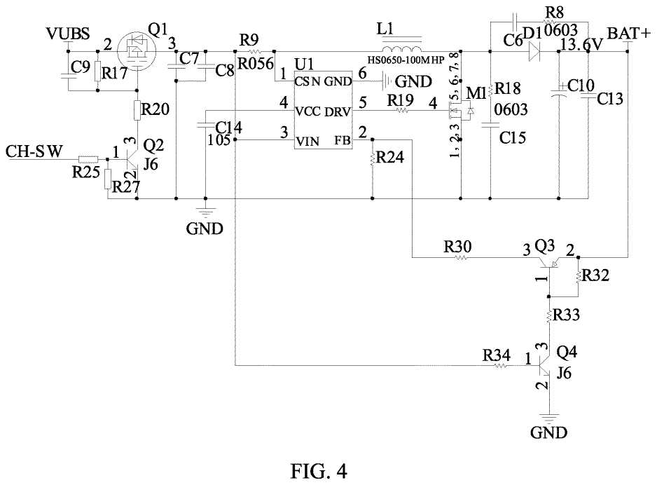

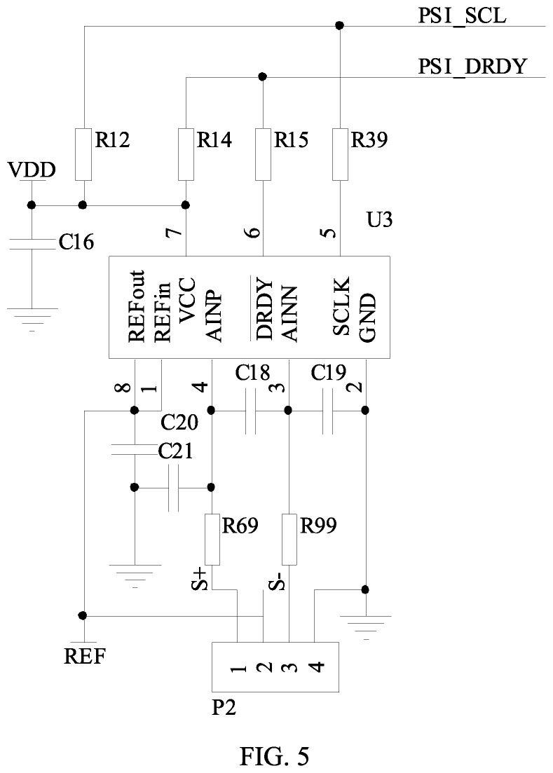

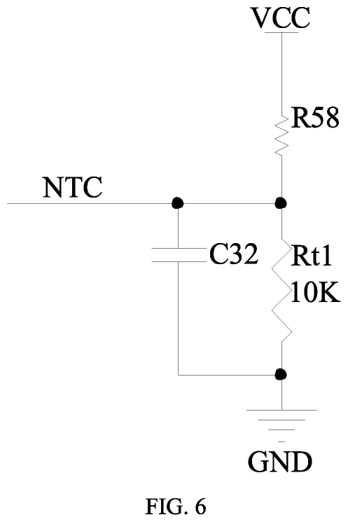

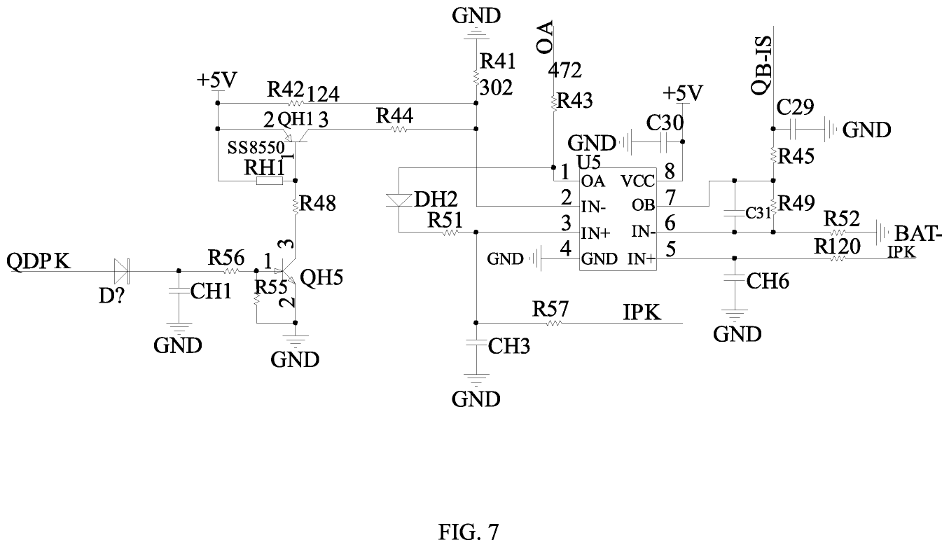

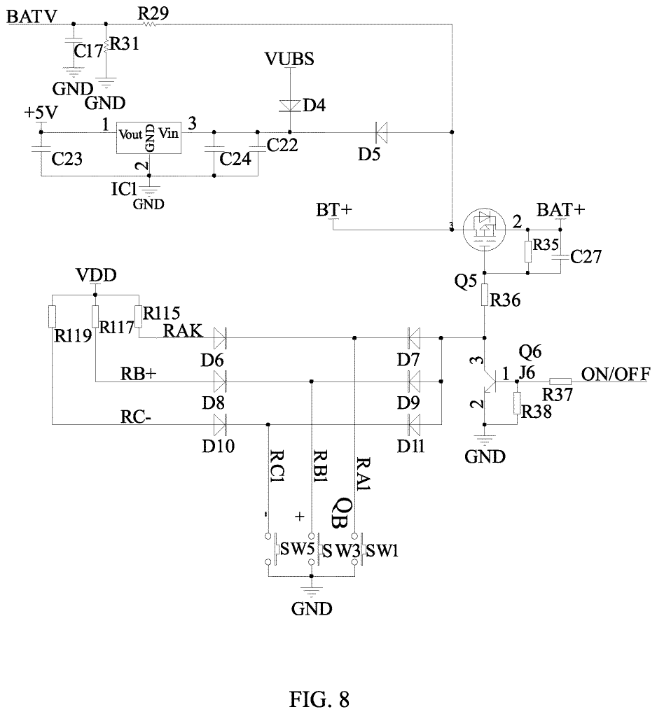

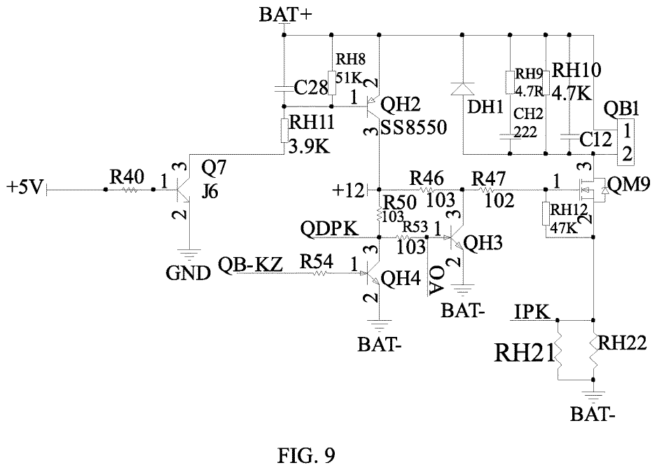

As shown in FIG. 1 to FIG. 12, a foot pump comprises:

A housing 1, configured to be placed on the ground;

A battery pack 2, arranged inside the housing 1 and used as a power supply;

An air pump 3, arranged inside the housing 1;

An air pipeline 4, connected with an air outlet of the air pump 3 and used for delivering compressed gas to an object to be inflated;

A foot switch board 5, arranged on the upper surface of the housing 1 for a user to touch with a foot or an object to trigger inflation operation;

The air pump 3 is connected with an air pump data detection module 6 and an air pump power control module 7, the air pump data detection module 6 is used for detecting an internal air pressure value of the object to be inflated, when the air pressure is lower than a set value, the air pump 3 is automatically started through the air pump power control module 7 to replenish air, and when the air pressure is automatically adjusted to the set value, the air pump automatically stops and maintains the pressure, achieving the functions of automatic pressure holding and automatic air replenishment.

The foot pump comprises a controller 8, the controller 8 is connected with a foot switch 9, the air pump data detection module 6, the air pump power control module 7, the battery pack 2, a zero-power shutdown control circuit 10, a temperature protection control module 11, a bidirectional USB circuit 12, an LED lighting lamp 13, an LED lamp switch circuit 14, and a battery level and air pressure display module 15, the battery pack 2 is connected with the air pump 3, the air pump 3 is connected with the air pump data detection module 6 and the air pump power control module 7, and the battery pack 2 is connected with the zero-power shutdown control circuit 10 and the bidirectional USB circuit 12.

The controller 8 is provided with a voltage detection module 16, and the voltage detection module 16 is connected with the battery pack 2; the controller 8 is provided with an on/off management module 17, and the on/off management module 17 is connected with the zero-power shutdown control circuit 10; the controller 8 is provided with a charging monitoring module 18, and the charging monitoring module 18 is connected with the battery pack 2; the controller 8 is provided with a temperature detection module 19, and the temperature detection module 19 is connected with the temperature protection control module 11; the controller 8 is provided with a USB control module 20 and a charging control module 21, and the USB control module 20 and the charging control module 21 are connected with the bidirectional USB circuit 12; the controller 8 is provided with an LED lighting lamp control module 22, the LED lighting lamp control module 22 is connected with the LED lighting lamp 13, and an output terminal of the LED lamp switch circuit 14 is connected with an input terminal of the LED lighting lamp control module 22; and the controller 8 is provided with a battery level and air pressure display control module 23, and the battery level and air pressure display control module 23 is connected with the battery level and air pressure display module 15.

The battery pack 2 is a titanium battery. The titanium battery is not flammable or explosive and has high safety.

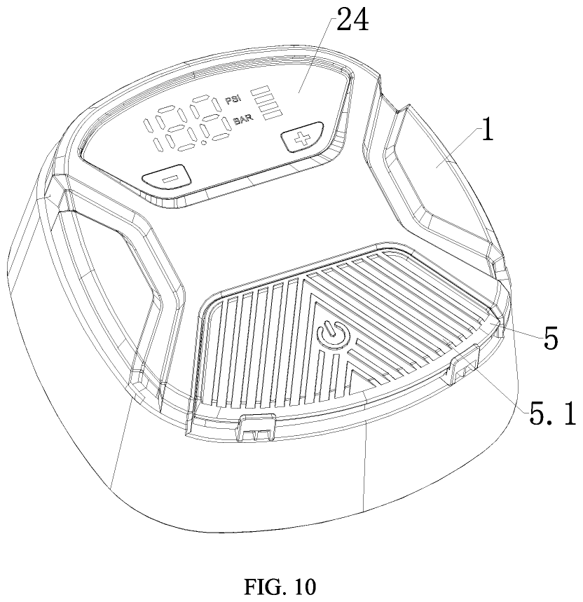

As shown in FIG. 10, the rear end of the top of the housing 1 is provided with a panel 24, the panel 24 has switchable air pressure units, and when the object is inflated to the set value, the foot pump automatically stops inflating and automatically cuts off the power supply of the battery pack 2. The panel 24 displays the current air pressure, set air pressure, battery level and other information in real time in the form of numbers and icons, and the air pressure units can be freely switched to meet the usage habits of different users.

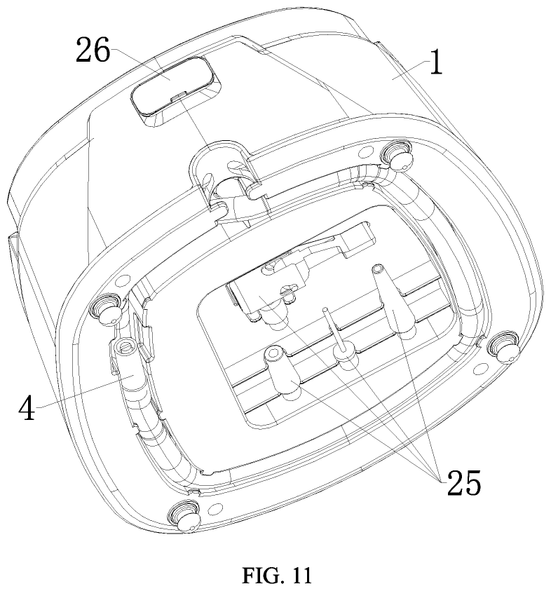

As shown in FIG. 11, a plurality of air nozzle adapters 25 are detachably fixed at the bottom of the housing 1 by means of clamping, which is convenient for storage and less likely to be lost; and the foot switch board 5 is arranged at the front end of the top of the housing 1, and the rear end of the housing 1 is provided with a charging and discharging port 26.

The housing 1 is composed of an upper housing 1.1 and a lower housing 1.2 distributed above and below, the air nozzle adapters 25 and the air pipeline 4 are installed at the bottom of the lower housing 1.2, and the panel 24 and the foot switch board 5 are installed at the top of the upper housing 1.1; the rear end of the housing 1 is provided with a TYPE-C board PCB 27 and a TYPE-C cover 28 for covering the charging and discharging port 26; an anti-vibration rubber pad 29 is arranged between the air pump 3 and the housing 1; and a mainboard 30, a sensor 31 and a battery pack PCB 32 are also installed in the housing 1. The sensor 31 is an air pressure sensor.

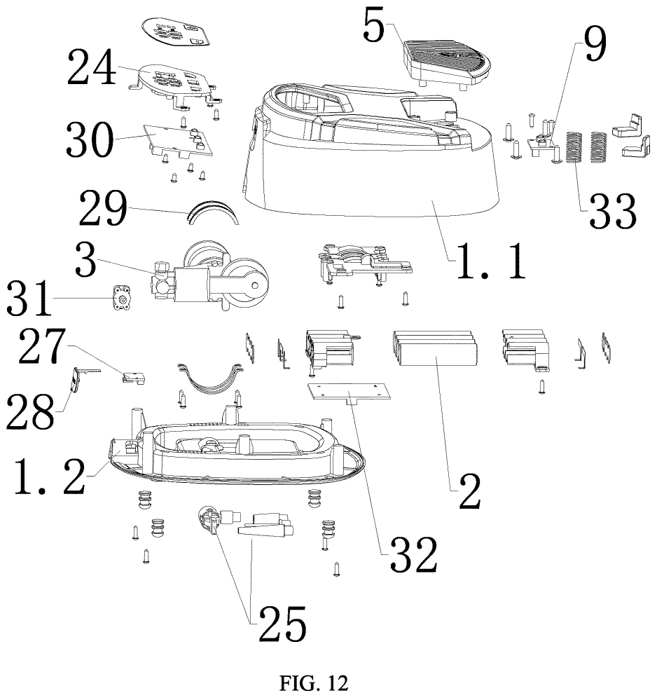

As shown in FIG. 12, the foot switch 9 located below the foot switch board 5 is installed in the upper end of the housing 1, and a spring 33 for driving the foot switch board 5 to reset is installed between the foot switch board 5 and the upper end of the housing 1. The foot switch board 5 is used in conjunction with the reset structure of the spring 33, and the foot switch board 5 can automatically return to the original position, facilitating continuous operation.

As shown in FIG. 10, the surface of the foot switch board 5 is provided with diversion trenches 5.1, which can effectively drain water and prevent slipping, making it safer to use in rainy or humid environments.

The present invention is easy to operate, time-saving and labor-saving, and the user only needs to touch the foot switch board 5 with a foot or any object to start inflation, with no need to bend over or hold, so the present invention is particularly suitable for the elderly, the disabled and people with limited physical strength;

The present invention monitors the internal air pressure of the object to be inflated in real time through the air pump data detection module 6, and combined with the air pump power control module 7, the air pressure value of the object to be inflated can be automatically adjusted according to the set air pressure value; when the object is inflated to the set value, the foot pump automatically stops and cuts off the power supply of the battery pack 2 to prevent overinflation; the foot pump also has the function of automatic pressure holding, maintaining a stable pressure after inflation is completed; and when the air pressure is lower than the set value, the foot pump can automatically replenish air;

In the present invention, with the arrangement of the zero-power shutdown control circuit 10, the power supply is automatically cut off after standby or completion of charging, greatly reducing power loss; the bidirectional USB circuit 12 supports external charging, enabling the air pump 3 to also serve as an emergency mobile power supply; and the temperature protection control module 11 monitors the operating temperature in real time to prevent overheat damage;

In the present invention, the LED lighting lamp 13 is arranged inside, which can provide illumination at night or in an environment with insufficient light, making it convenient for users to connect the air nozzle or check the inflation status, thereby enhancing practicality and safety;

In the present invention, the plurality of air nozzle adapters 25 are detachably fixed at the bottom of the housing 1 by means of clamping, which is convenient for storage and less likely to be lost; and the anti-vibration rubber pad 29 is arranged between the housing 1 and the air pump 3 to reduce operating noise and vibration.

Of course, the above only describes the preferred embodiments of the present invention, and does not limit the scope of the patent of the present invention. All simple modifications and equivalent structural changes made by using the description and schematic content of the present invention shall be included within the protection scope of the patent of the present invention in the same way.

What is claimed is:

1. A foot pump, comprising:
a housing, configured to be placed on the ground;
a battery pack, arranged inside the housing and used as a power supply;
an air pump, arranged inside the housing;
an air pipeline, connected with an air outlet of the air pump and used for delivering compressed gas to an object to be inflated;
a foot switch board, arranged on the upper surface of the housing for a user to touch with a foot or an object to trigger inflation operation;
the air pump is connected with an air pump data detection module and an air pump power control module, the air pump data detection module is used for detecting an internal air pressure value of the object to be inflated, when the air pressure is lower than a set value, the air pump is automatically started through the air pump power control module to replenish air, and when the air pressure is automatically adjusted to the set value, the air pump automatically stops and maintains the pressure, achieving the functions of automatic pressure holding and automatic air replenishment.

2. The foot pump according to claim 1, comprising a controller, wherein the controller is connected with a foot switch, the air pump data detection module, the air pump power control module, the battery pack, a zero-power shutdown control circuit, a temperature protection control module, a bidirectional USB circuit, an LED lighting lamp, an LED lamp switch circuit, and a battery level and air pressure display module, the battery pack is connected with the air pump, the air pump is connected with the air pump data detection module and the air pump power control module, and the battery pack is connected with the zero-power shutdown control circuit and the bidirectional USB circuit.

3. The foot pump according to claim 2, wherein the controller is provided with a voltage detection module, and the voltage detection module is connected with the battery pack; the controller is provided with an on/off management module, and the on/off management module is connected with the zero-power shutdown control circuit; the controller is provided with a charging monitoring module, and the charging monitoring module is connected with the battery pack; the controller is provided with a temperature detection module, and the temperature detection module is connected with the temperature protection control module; the controller is provided with a USB control module and a charging control module, and the USB control module and the charging control module are connected with the bidirectional USB circuit; the controller is provided with an LED lighting lamp control module, the LED lighting lamp control module is connected with the LED lighting lamp, and an output terminal of the LED lamp switch circuit is connected with an input terminal of the LED lighting lamp control module; and the controller is provided with a battery level and air pressure display control module, and the battery level and air pressure display control module is connected with the battery level and air pressure display module.

4. The foot pump according to claim 1, wherein the battery pack is a titanium battery.

5. The foot pump according to claim 1, wherein the rear end of the top of the housing is provided with a panel, the panel has switchable air pressure units, and when the object is inflated to the set value, the foot pump automatically stops inflating and automatically cuts off the power supply of the battery pack.

6. The foot pump according to claim 5, wherein a plurality of air nozzle adapters are detachably fixed at the bottom of the housing by means of clamping, the foot switch board is arranged at the front end of the top of the housing, and the rear end of the housing is provided with a charging and discharging port.

7. The foot pump according to claim 5, wherein the housing is composed of an upper housing and a lower housing distributed above and below, the air nozzle adapters and the air pipeline are installed at the bottom of the lower housing, and the panel and the foot switch board are installed at the top of the upper housing; the rear end of the housing is provided with a TYPE-C board PCB and a TYPE-C cover for covering the charging and discharging port; an anti-vibration rubber pad is arranged between the air pump and the housing; and a mainboard, a sensor and a battery pack PCB are also installed in the housing.

8. The foot pump according to claim 5, wherein the foot switch located below the foot switch board is installed in the upper end of the housing, and a spring for driving the foot switch board to reset is installed between the foot switch board and the upper end of the housing.

9. The foot pump according to claim 1, wherein the surface of the foot switch board is provided with diversion trenches.
